(19) United States
(12) Patent Application Publication
(10) Pub. No.: US 2006/0180179 A1
(43) Pub. Date: Aug. 17, 2006

(54) Dishwasher for kosher operation

(75) Inventors: Thomas Roderer, Hohberg-Niederschopfheim (DE); Norbert Suhm, Gegenbach (DE)

Correspondence Address: BIRCH STEWART KOLASCH & BIRCH, PO BOX 747, FALLS CHURCH, VA, 22040-0747, US

(73) Assignee: MEIKO Maschinenbau GmbH, Offenburg (DE)

(21) Appl. No.: 10/551,963

(22) PCT Filed: Dec. 3, 2004
(86) PCT No.: PCT/EP04/13764

§ 371 Date: Oct. 5, 2005

(30) Foreign Application Priority Data
Dec. 8, 2003 (DE) 103 57 256.2

(51) Int. Cl. B08B 7/04; B08B 9/20

(52) U.S. Cl. 134/18; 134/25.2

(57) ABSTRACT

The invention relates to an automatic dishwasher (1) which can be operated in several operating modes (71, 72, 73, 74). The automatic dishwasher (1) proposed according to the invention can be switched from a first operating mode (71) to a second operating mode (72) only when a third operating mode (73) called kosher operation is executed. During the third operating mode (73) “Kosher operation”, the interior of the automatic dishwasher (1) is cleaned with a heated cleaning fluid whose temperature lies above the maximum temperature occurring in the normal operation of the automatic dishwasher (1). The endless conveyor belt (10) of the automatic dishwasher (1) is treated by a cleaning device (43) during the third operating mode (73) “Kosher operation”; moreover, a water tank (25) of the automatic dishwasher (1) is heated to a higher temperature than the temperature which occurs in the normal operation of the automatic dishwasher (1). In an operating mode called “Sabbath operation”, the current to the drive mechanism of the automatic dishwasher is interrupted via a light barrier (52).

### TECHNICAL FIELD

The invention relates to a dishwasher, in particular a belt-type dishwasher used for commercial purposes. The dishwasher proposed according to the invention can be used both in kosher operation and also on religious holidays such as the Sabbath.

### PRIOR ART

The company brochure entitled “Geschirrspülautomat mit Bandtransport” [Automatic dishwasher with conveyor belt] from the company Meiko Maschinenbau GmbH & Co. KG No. 2031.03.03/KD/4.000D discloses a conveyor belt automatic dishwasher in which the material to be cleaned is transported on an endless conveyor belt. The material to be cleaned is placed on the conveyor belt at the machine inlet and first passes through a dirt removal area. By means of spray nozzles from which the material to be cleaned is sprayed with water jets from the underside and from above, food residues falling down in the dirt removal area are cleared away. The machine inlet is covered by a hood. Located underneath the conveyor belt there are one or more coarse sieves which trap the falling food residues. The smallest food residues can be collected via a fine sieve arranged under the coarse sieve(s). Located below the fine sieve, there is in turn a collecting vessel for the rinse water dripping from the removed dirt.

Viewed in the direction in which the material to be cleaned is conveyed, the machine inlet and the adjoining rough cleaning area are followed by several rinse zones lying one after the other. Inside these rinse zones, the material to be cleaned is treated with hot rinse water. The hot rinse water issues both from spray nozzles arranged underneath the endless conveyor belt and also from spray nozzles which rinse the material from the top. After passing through a first rinse zone, the material to be cleaned is conveyed by the endless conveyor belt into at least one further rinse zone in which it is likewise rinsed by being sprayed. The rinse water issuing from the spray nozzles in said rinse zones is heated to a higher temperature at which the material placed on the endless conveyor belt is rinsed off. After the second rinse zone, the material to be cleaned can be transported either into a final rinse zone or into a further rinse zone.

A collecting vessel of cascade-like configuration is provided underneath the rinse zones and the final rinse zone. The collecting vessel is divided into individual segments by individual dividing walls. The dividing walls are dimensioned such that, when a certain water level is reached in each segment, an overflow of the rinse water into the preceding segment is ensured. Each segment of the rinse water tank is assigned a wash pump with which from the respective segment of the rinse water storage tank, after previous filtering of the wash liquor, rinse water is delivered to the individual spray nozzles of the respective rinse zone or final rinse zone.

Downstream of the final rinse zone of the known automatic conveyor belt, there is a heat recovery unit, which can optionally be assigned an exhaust air cleaning unit. This unit is followed by a drying fan via which warm air can be applied to the cleaned and rinsed material, so that the latter is dried and cooled as it goes through the drying process. The drying station is followed by an outlet for the dishes, at which outlet the cleaned, rinsed and dried dishes can be removed from the automatic conveyor belt either manually or in an automated manner. On the operator side of the automatic conveyor belt known from said company brochure, the individual rinse zones are accessible via screens which can be put up. Under the screens there are curtain elements with which the individual rinse zones are provided in order to prevent spray water escaping to the sides. In automatic dishwashers with a conveyor belt, it is standard practice for one set of curtains to be provided per rinse zone.

Kosher food is defined in accordance with Jewish religious law, which is set down in the Torah, the centerpiece of the Jewish faith. The word kosher signifies everything that has been produced or prepared according to Jewish law. Kosher diet follows the rules of kashrut (Jewish dietary laws). In accordance with kashrut, only four-footed animals that chew their cud and have cloven hooves may be eaten. This excludes pigs or hares, for example. Poultry, by contrast, is kosher.

Of fish, only those that have fins and scales may be eaten. The fifth Book of Moses is the basis of the prohibition on eating meat at the same time as milk or milk products. After eating meat, 6 hours must pass before a milk product is eaten or drunk. The rules also include using separate pots, cutlery and dishes for these foods. The Torah, as the centerpiece of Jewish faith, further prohibits the consumption of blood. Meat must be treated in a special way, by which is meant extracting excess blood, then washing the meat and subsequently sprinkling it with salt. This way of treating meat also involves a ritual method of slaughter, namely kosher slaughter.

In view of these underlying principles of the Jewish faith, it was hitherto necessary to ensure that dishes which came into contact with milk products were cleaned in one dishwasher and that dishes which came into contact with meat or meat products were rinsed and cleaned in another dishwasher separate from the first one. This means a considerable outlay in terms of the work involved, the investment costs and the space taken up, in order to comply with the dietary laws of kashrut as regards the cleaning of dishes.

A further precept of Jewish faith commands that no flame be kindled during the Sabbath. Actuating an electric switch is equated to kindling flame. However, the operation of electrically driven machines requires, irrespective of the operating states, or in the event of a malfunction, the intervention of a machine operator, which nowadays entails actuating a switch. If a dishwasher such as the conveyor belt dishwasher known from the aforementioned company brochure is operated during the Sabbath, malfunctions will result in the electrically driven dishwasher shutting down for quite long periods, the possible consequence of which is considerable down times if immediate intervention is not possible, because to intervene would require actuation of an electric switch.

### DISCLOSURE OF THE INVENTION

In view of the precepts of the Jewish faith outlined above, the object of the invention is to design a dishwasher, in particular a dishwasher which can be used on a commercial scale, in such a way that dishes which have been in contact with milk products and dishes which have been in contact with meat can be cleaned in one and the same dishwasher, and the same dishwasher can also be operated without disruption during the Sabbath or other Jewish holy days.

According to the invention, this object is achieved by the features of patent claim 1.

The main advantage of the solution proposed according to the invention can be seen to be the fact that different types of dishes can now be cleaned in one and the same commercially usable dishwasher, this being understood to mean, in particular, dishes which have previously been in contact with milk products and also dishes which have been in contact with meat or meat products. By performing a “Kosher cleaning operation” between an operating mode in which dishes that have been in contact with milk products are cleaned and an operating mode in which dishes that have been in contact with meat or meat products are cleaned, a kosher operation is conducted, after which the entire machine is cleaned with a cleaning fluid. In accordance with the precepts of Jewish faith, the cleaning fluid is brought to a temperature which is up to 10° C. above the maximum temperature that occurs in the normal operation in the dishwasher.

Moreover, the automatic dishwasher with conveyor belt that can be used by those of the Jewish faith also comprises a cleaning system which serves to clean the endless conveyor belt carrying the material to be cleaned. This belt remains in the automatic dishwasher during the operating mode “Cleaning of dishes having been in contact with milk products” and also during the operating mode “Cleaning of dishes having been in contact with meat or meat products” in the machine, and it is cleaned by a cleaning device during the kosher operation. A cleaning step for cleaning the belt takes place between the manual cleaning of the machine and a “Kosher operation”. This can be done, for example, by cleaning brushes assigned to the endless conveyor belt. These are arranged in such a way that the endless conveyor belt is brushed clean by cleaning brushes both from the top and also from underneath. The endless conveyor belt is made from plastic and is built permanently into the automatic dishwasher. It constitutes a large plastic component that cannot be exchanged. However, to be able to use the endless conveyor belt remaining in the automatic dishwasher both in the operating mode “Cleaning of dishes having been in contact with milk products” and also in the operating mode “Cleaning of dishes having been in contact with meat or meat products”, the endless conveyor belt is brushed mechanically prior to the “Kosher operation”.

The dishwasher which is proposed according to the invention, and which can be used by those of the Jewish faith, also comprises a curtain which can be suspended into the individual rinse zones and is exchangeable and which, during the kosher operation, when switching between one of the operating modes “Cleaning of dishes having been in contact with milk products” and “Cleaning of dishes having been in contact with meat or meat products”, is suspended as curtain into the individual rinse zones that are accessible from the operator side of the automatic dishwasher.

In view of the kosher laws of the Torah, the centerpiece of Jewish faith, provision can also be made for the rinse water tank of the automatic dishwasher according to the invention to be heated to a temperature which is above the maximum rinse water temperature or fresh water temperature occurring in the normal operation of the dishwasher. In this context, it is also possible to describe the interior of the water tank of the automatic dishwasher as being made kosher.

In the machine control unit of an automatic dishwasher of this design, switching from the operating mode “Cleaning of dishes for milk products” and “Cleaning of dishes for meat/meat products” is possible only when a “Kosher operation” has taken place and the endless conveyor belt has been cleaned between the switching between said operating modes. Direct switching from one operating mode of the automatic dishwasher according to the invention to the respective other operating mode is not possible and is prevented by the machine control unit.

In the machine control unit, a further implementation is that during the Sabbath, so as to avoid kindling a flame, i.e. by actuation of an electric switch by an operator, the proposed automatic dishwasher switches off automatically in emergency situations. In the Sabbath operating mode, it must be ensured that, if a malfunction occurs, the dishwasher is switched off automatically by the machine control unit, without an operator having to do anything. Thus, for example, the automatic conveyor belt drive can be switched off by means of the fact that, in the absence of a reflected optical signal in a light barrier, the forward movement of the belt and the pump operation are switched off without requiring the intervention of an operator.

For the Sabbath operating mode, it is provided that the conveyor belt automatic dishwasher runs at a certain speed in respect of the forward movement of the endless conveyor belt. For each operating mode, i.e. for “Cleaning of dishes having been in contact with milk products” and “Cleaning of dishes having been in contact with meat or meat products”, timers are built in. The automatic dishwasher is rendered operative through the operation of a switch, which can be designed for example as a key switch. The actual start-up of the automatic dishwasher during the Sabbath is effected by the timer assigned to the respective operating mode.

In accordance with the selected operating mode, the first curtains assigned to this for the operating mode “Cleaning of dishes having been in contact with milk products” or the second curtains for the operating mode “Cleaning of dishes having been in contact with meat or meat products” are suspended into the automatic dishwasher. The automatic dishwasher begins in the respective operating mode with the function of filling or heating of the water tank. After the desired temperature is reached, the actual rinse procedure begins in the respectively selected operating mode, until the timer stops the operating mode. Thereafter, the curtains assigned to the respective operating mode are replaced by the curtains required in the operating mode “Kosher operation”, because a “Kosher operation” is necessary. When the timer assigned to the preceding selected operating mode switches off, the “Kosher operation” is thus triggered. At the end of the “Kosher operation”, a rinse procedure is started anew depending on the setting of the timers for the operating mode “Cleaning of dishes having been in contact with milk products” or the operating mode “Cleaning of dishes having been in contact with meat or meat products”. To operate the automatic dishwasher again on workdays, the Sabbath operating mode has to be switched off via the corresponding switch.

If, during the Sabbath operating mode, there is a power outage or a main switch off state, the automatic dishwasher switches back to the normal Sabbath operating mode once voltage has been recovered after the power outage, and the automatic dishwasher begins the program sequence with filling/heating of the water tanks.

If a belt limit switch is activated during the Sabbath operating mode, which happens when a dish not removed from the endless conveyor belt strikes against a limit switch function, the drive mechanism of the endless conveyor belt is switched off. In this way, a light barrier is switched to a voltageless state. In a cycle of, for example, 15 seconds, the supply voltage of the light barrier is switched on by a short impulse. If it is thus detected that the limit switch is free again, the drive mechanism of the endless conveyor belt switches on. By contrast, if the limit switch is detected as being not yet free, the supply voltage is cut out again for a period of about 15 seconds. In the case of an emergency off function, which can occur through actuation of the corresponding switch, the automatic dishwasher switches off completely. The emergency off switch is switched to a voltageless state. The supply voltage of the emergency off switch is switched back on every 60 seconds by a short impulse. When the emergency off switch is released again, the automatic dishwasher resumes the rinse program with a step “Start rinse operation on Sabbath”. If the emergency off switching in the Sabbath operating mode takes place during the “Kosher operation”, the operating mode “Kosher operation” then continues as normal after disconnection of the emergency off switch. If, at the time of the emergency off switching, the automatic dishwasher is in the operating mode “Sabbath operation” and is there in a wash program, the machine program resumes with the step “Heating prior to kosher operation” after the emergency off switch has been disconnected.

By contrast, if the emergency off switch is not released, the voltage supply is again cut off for a period of about 60 seconds.

If overloading of the endless conveyor belt is detected in the Sabbath operation of the automatic dishwasher, as may happen for example if a dish or cutlery blocks the forward movement of the belt, the rinse operation is automatically switched off. The belt overload switch is switched to a voltageless state. It is switched back on again, for example within a time slot of 30 seconds, by means of a short impulse of the supply voltage. If the belt overload switch is disconnected, the rinse operation begins again after a hooter sound. By contrast, if the belt overload switch is not disconnected, the supply voltage is cut out for a time slot of 30 seconds. This cycle of switching on and off of the belt overload switch will take place up to 3 times. If, after the third occasion, the belt overload switch is detected as still not being free, the cycle is increased to 5 minutes. When this cycle of 5 minutes has also taken place 3 times without success, the automatic dishwasher switches off completely and can no longer be started automatically in the Sabbath operating mode.

### DRAWING

The invention is described in more detail below with reference to the drawing, in which:

FIG. 1 shows a cross section through an automatic dishwasher equipped according to the invention and with a conveyor belt,

FIG. 2 shows the overflow or outflow system of a conveyor belt automatic dishwasher,

FIG. 3 shows the machine outlet with a movably mounted limit switch,

FIG. 4 shows the view of a light barrier arrangement,

FIG. 5 shows the connection between a mirror surface and a limit switch,

FIG. 6 shows a deflected limit switch, and

FIG. 7 shows a control panel for a machine control unit of an automatic dishwasher according to the view in FIG. 1.

### EMBODIMENT VARIANTS

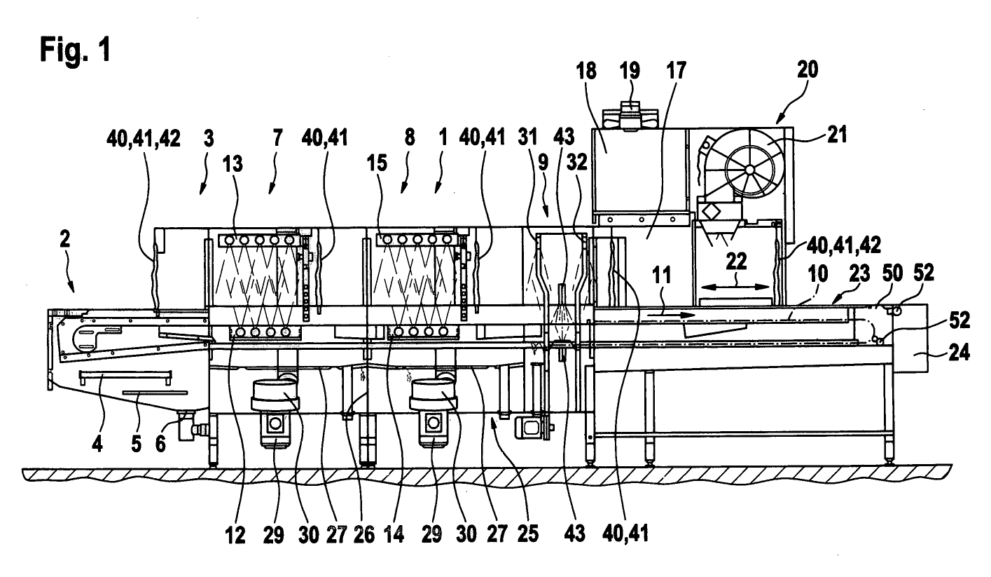

The view according to FIG. 1 shows an automatic dishwasher with conveyor belt. At the machine inlet 2, the material to be cleaned is placed on an endless conveyor belt 10. The endless conveyor belt 10 is moved continuously by means of a drive mechanism 24 arranged in the area of an outlet 23 for the dishes and conveys the material to be cleaned through the conveyor belt automatic dishwasher. Inside a rough cleaning area 3, large residues of food are rinsed off and fall into a coarse sieve 4 arranged under the endless conveyor belt 10, under which coarse sieve 4 a fine sieve 5 can optionally be arranged. Underneath the fine sieve 5 there is a common outflow 6 in which the rinsing water is collected. After passing through the rough cleaning area 3, the material to be cleaned is transported into a first rinse zone 7, which can be followed by a second rinse zone 8 or even by several further rinse zones. The dishes cleaned beforehand in the first rinse zone 7 and in the second rinse zone 8 or the further rinse zones are then given a final rinse in a final rinse zone 9. The endless conveyor belt 10 is fed through the conveyor belt automatic dishwasher 1 in the direction of advance 11.

In the first rinse zone 7, there are upper spray nozzles 13 above the material to be cleaned, and lower spray nozzles 12 under the endless conveyor belt 10, via which nozzles the material to be cleaned is sprayed with rinse water. During the operation of the conveyor belt automatic dishwasher 1, the first rinse zone 7 is closed laterally against escaping spray water. Viewed in the direction of advance 11 of the material to be cleaned, a preliminary clearing area 3 is closed off by a first curtain 40 against outwardly escaping spray water. The first rinse zone 7 following on from the preliminary clearing area 3 is separated by a further first curtain 40 from the second rinse zone 8 at whose outlet—seen in the direction of advance 11 of the material to be cleaned—there is a further first curtain 40. The final rinse zone 9 following on from the second rinse zone and comprising a pump final rinse 31 and a fresh water final rinse 32 is delimited from a heat recovery module 17 by a further first curtain 40. Downstream of the drying zone 22 there is a further first curtain 40 with which the drying zone 22 is screened off from the outside in the direction of the outlet 23 for the dishes. Situated underneath the first rinse zone 7 there is a segment of a water tank 25. The segment of the water tank 25 assigned to the first rinse zone 7 is separated by a dividing wall 26 from other segments of the water tank 25. Situated on the bottom of the water tank assigned to the first rinse zone 7 there is a circulating pump 29 for the rinse water, which pump is assigned a filter 30. The individual dividing walls 26 which divide the water tank 25 into individual segments assigned to the rinse zones 7 and 8 or the final rinse zone 9 can, for example, be designed as sheet metal walls.

The lower and upper spray nozzles 12, 13 are supplied with circulated rinse water via the circulating pump 29 assigned to the first rinse zone 7.

After passage through the first rinse zone 7, as the endless conveyor belt 10 moves in the direction of advance 11, the material to be cleaned which is received on said conveyor belt moves into a second rinse zone 8. Inside the second rinse zone 8 there are upper spray nozzles 15 and lower spray nozzles 14. By means of these spray nozzles, the material to be cleaned is subjected to further rinsing inside the second rinse zone 8 with rinse water which is brought to an increased temperature. While the temperature of the rinse water received in the water tank 25 and of the heated fresh water introduced into the final rinse zone 9 is about 80° C. to 85° C., the water sprayed inside the preliminary clearing area 3 has a temperature of maximum 42° C., which satisfies kosher requirements. A lower temperature of the water sprayed inside the preliminary clearing area 3 would entail the disadvantage of fat gathering on the material to be cleaned.

The second rinse zone 8 is also assigned a segment of the water tank 25 on whose base a circulating pump 29 with associated filter 30 is received. The upper spray nozzles 15 and the lower spray nozzles 14 are supplied with rinse water via this circulating pump 29 assigned to the segment of the water tank 25 for the second rinse zone 8.

In the direction of advance 11 of the material to be cleaned, the second rinse zone 8 is followed by a final rinse zone 9. The material cleaned beforehand in the first rinse zone 7 and in the second rinse zone 8 is subjected to a final rinse inside the final rinse zone 9 with addition of a rinse aid, so that the material to be cleaned is cleaned stain-free. The final rinse zone 9 is also assigned a pump with which the spray nozzles in the final rinse zone 9 are supplied with fresh water, possibly with addition of a cleaner or rinse aid. In the final rinse zone 9 there is a pump final rinse 31 and a pure fresh water final rinse 32.

In the direction of advance 11 of the material to be cleaned, the final rinse zone 9 is followed by a heat recovery module 17 in which a cooling register 18 is received. The heat recovery module 17 additionally comprises a fan 19.

Downstream of the heat recovery module 17 there is a drying module 20 in which a hot air dryer 21 designed as a fan is arranged. As it passes through the drying zone 22, the cleaning material received on the endless conveyor belt 10 and previously cleaned and rinsed is dried and cooled so that it can be removed from the endless conveyor belt 10 at the outlet 23 for the dishes. The drive mechanism 24 (not shown in detail in FIG. 1) for the endless conveyor belt 10 is also accommodated in the outlet area 23 for the dishes.

In addition, the conveyor belt automatic dishwasher 1 according to the invention comprises a cleaning device 43 with which the endless conveyor belt 10 made of plastic and accommodated in the machine can be cleaned both on its upper face and also on its lower face. The cleaning device 43, formed by a pair of oppositely arranged brushes, is disposed between the pump final rinse 31 and the fresh water final rinse 32.

In addition, the conveyor belt automatic dishwasher 1 according to the view in FIG. 1 comprises a limit switch 50 which is assigned a first light barrier 52, and a further, second light barrier 52 which detects overloading of the drive mechanism 24 of the endless conveyor belt 10 and switches off the drive mechanism 24, for example if an item to be cleaned obstructs the movement of the endless conveyor belt 10.

When the conveyor belt automatic dishwasher 1 shown in FIG. 1 is used in the operating mode “Cleaning of dishes for milk products”, the first rinse zone 7 and the second rinse zone 8 and the entry side in the area of the machine inlet 2 and the exit side in the area of the outlet 23 for dishes are protected by first curtains 40. Accordingly, in this operating mode, spray water contaminates only the first curtains 40.

In the operating mode “Cleaning of dishes for meat/meat products”, the first curtains 40 are replaced by second curtains 41 which accordingly, in this operating mode, by virtue of the spray water created there, come into contact with the spray water created in this operating mode.

Switching from one of said operating modes to the respective other operating mode is prohibited by the machine control system in conveyor belt automatic dishwashers used by people of the Jewish faith. Before switching the operating mode, an operating mode called “Kosher operation” is enforced which necessitates changing the first curtains 40 in the automatic dishwasher 1 for the operating mode “Cleaning of dishes for milk products” or the second curtains 41 for the operating mode “Cleaning of dishes for meat/meat products” by suspension of a third curtain 42 for the operating mode called “Kosher operation”. In the context of the operating mode called “Kosher operation”, the third curtains 42 are suspended only at the inlet to the preliminary clearing area 3 in the region of the machine inlet 2 and downstream of the drying zone 22 at the exit to the outlet 23 for the dishes.

In the operating mode “Kosher operation”, which is enforced when switching from said operating modes for “Cleaning of dishes for milk products” and “Cleaning of dishes for meat/meat products”, the whole of the interior of the conveyor belt automatic dishwasher 1 is cleaned with a cleaning medium which is heated to up to 90° C. to 95° C., that is to say to a temperature which is higher than the operating temperature of about 85° C. which is the maximum that occurs in the operation of the conveyor belt automatic dishwasher 1. By cleaning the whole of the inner area of the conveyor belt automatic dishwasher 1 coming into contact with spray water, according to the view in FIG. 1, it is possible to ensure, in accordance with the customs of the Jewish faith, that any food residues or spray water residues which could be tainted either with milk product residues or meat product residues are removed and the conveyor belt automatic dishwasher 1 is kosher within the meaning of the Jewish faith.

In the operating mode “Kosher operation”, the endless conveyor belt 10 is also cleaned by a cleaning device 43 so that both the lower face of the endless conveyor belt 10 and also its upper face are brushed clean mechanically. In this way, the endless conveyor belt 10 consisting of individual plastic components is kosher within the meaning of the Jewish kashrut.

The replacement of the first curtains 40 and second curtains 41 by a third curtain 42 to be used only in the operating mode “Kosher operation” prevents contamination of the respective curtain in the operating mode “Cleaning of dishes for milk products”, i.e. of the first curtains 40 or the second curtains 41 which, in the operating mode “Cleaning of dishes for meat/meat products”, are suspended at the appropriate suspension positions of the conveyor belt automatic dishwasher 1.

Heating the water tank 25 in the operating mode “Kosher operation” ensures that its content too is kosher within the meaning of kashrut.

The conveyor belt automatic dishwasher 1 shown in FIG. 1 has a limit switch 50 which triggers automatic switching-off of the drive mechanism 24 of the endless conveyor belt 10. The limit switch 50 is assigned a first light barrier 52, while the drive mechanism 24, which is preferably mounted on a rocker, is assigned a second light barrier 52. Said first and second light barriers 52 are described in more detail in connection with the operating mode called “Sabbath operation”.

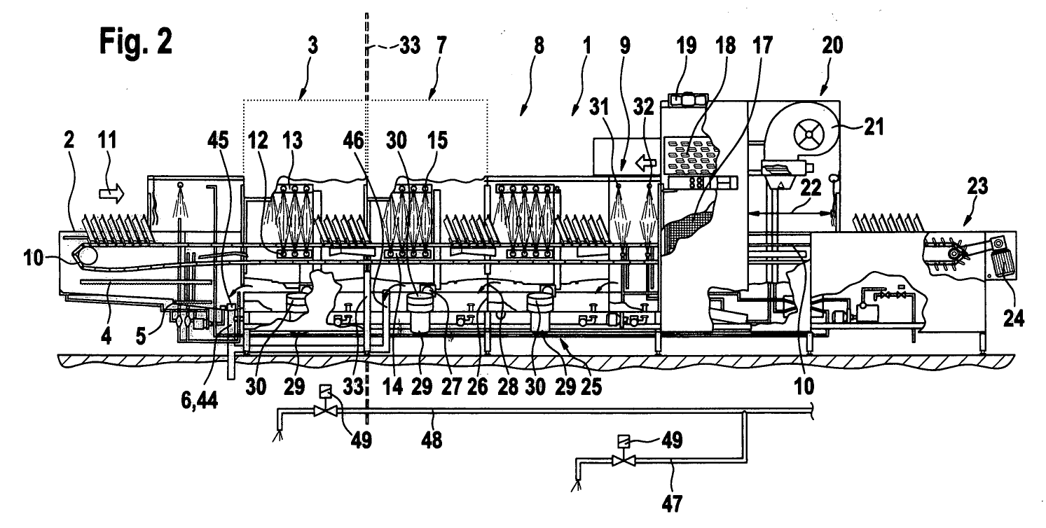

FIG. 2 shows the overflow or outflow system of a conveyor belt automatic dishwasher suitable for kosher operation. In the area of the final rinse zone 9, a first filling line 47 from a fresh water connection (not shown) opens into the inside of the segment of the water tank 25 underneath the final rinse zone 9. A valve 49 is accommodated in the first filling line 47. The dividing wall of the segment of the water tank 25 underneath the final rinse zone 9 is designed as an overflow 28, so that water can overflow like a cascade into the segment of the water tank 25 underneath the second spray zone 8. The dividing wall 26 of the segment underneath the second final rinse zone 8 is likewise designed as an overflow 28. The water flows via this overflow 28 into the segment of the water tank 25 underneath the first rinse zone 7. The segment of the water tank 25 underneath the first rinse zone 7 comprises a second outflow 46 since the segment of the water tank 25 underneath the first rinse zone 7 is separated from the preliminary clearing area 3 by a dividing wall 33.

The filling of the segment of the water tank 25 underneath the preliminary clearing area 3 is effected via a second filling line 48 into which a valve 49 is likewise incorporated. The outflow of the water from the segment of the water tank 25 underneath the preliminary clearing area 3 is effected via an outflow 45 which opens into the common outflow 6 of the conveyor belt automatic dishwasher 1. The waste water of the conveyor belt automatic dishwasher flows via this into a waste water system.

Each of the segments of the water tank 25 is assigned a circulating pump 29 and a filter 30. The supply of fresh water to the preliminary clearing area 3 via the second filling line 48 takes place separately. The water used in the preliminary clearing area 3 only has a temperature of at maximum 42° C., whereas the water sprayed into the first rinse zone 7 and into the second rinse zone 8 and into the final rinse zone 9 has a temperature in the range of between 55° C. and 85° C.

The conveyor belt automatic dishwashers 1 shown in each case in cross section in FIGS. 1 and 2 have a division of the tank segment of the preliminary clearing area 3 in respect of the cascade water flowing over via the overflows 28 from the segments of the storage tank 25 of the first rinse zone 7 and of the second rinse zone 8 and the final rinse 9. Accordingly, the conveyor belt automatic dishwasher has two outflows 45, 46. The waste water is brought together in the common outflow 6 outside said tanks. The distance between the last washing arm of the preliminary clearing area 3 and the tank division 33 is at least 40 cm. The segment of the storage tank 25 assigned to the preliminary clearing area 3 has its own separately controlled tank heater, since the temperature of the water used in the preliminary clearing area 3 in rinse mode must not exceed a temperature of 42° C. In the conveyor belt automatic dishwasher 1 proposed according to the invention, there are no rinse temperatures higher than 85° C. The limit switch 50 is interrogated not via a solenoid switch, but via a first light barrier 52. Two sets of lower and upper belt brushes are used as cleaning device 43, these being arranged between the pump final rinse 31 and the fresh water final rinse 32. In respect of an automatic program sequence in the operating mode “Sabbath operation”, the waste water pumps used are provided in all segments of the storage tank 25.

Whereas in the operating mode “Sabbath operation” of the conveyor belt automatic dishwasher 1, the operating mode “Kosher operation” is automatically started after each rinse operation, outside the Sabbath, i.e. on normal weekdays, the operating mode “Kosher operation” is started manually. For this purpose, the third curtains 42 have to be suspended before the start of the operating mode “Kosher operation”. The kosher process then starts, the outflow pumps are activated, an overrun time of the outflow pumps of about 2 minutes being guaranteed. During a subsequent time interval of approximately 30 minutes, the belt conveyor automatic dishwasher 1 can be cleaned manually. During the abovementioned time interval of 30 minutes needed for the manual cleaning, the outflow pumps pump cyclically (cycle: every 2 minutes for 30 seconds). Thereafter, the cleaning device 43 is used which can be designed as a pair of brushes which in each case brush clean the upper face and the lower face of the endless conveyor belt 10. The endless conveyor belt 10 runs at the maximum speed and the final rinse inside the final rinse zone 9 is in operation. This process step lasts for two complete revolutions of the endless conveyor belt 10 at the maximum speed. During the belt-cleaning process, the outflow pumps pump the water off. After the belt-cleaning process is completed, the conveyor belt automatic dishwasher 1 is filled and the water is heated to a kosher temperature of about 95° C. Once the kosher temperature has been reached in each of the segments of the storage tank 25, the operating mode “Kosher operation” starts. This means that the circulating pumps 29, the drive mechanism of the endless conveyor belt 10 and the exhaust air suction are in operation. The duration of the operating mode “Kosher process” is limited to two complete belt revolutions at a medium machine speed. Thereafter, all segments of the storage tank 25 are emptied. This is followed by removal of the cleaning device 43 and withdrawal of the third curtains 42 at the machine inlet 2 and at the outlet 23 for the dishes.

The operating mode “Kosher operation” which runs between the operating mode “Cleaning of dishes for milk products” and the operating mode “Cleaning of dishes for meat/meat products” cannot be interrupted, except in workday operation where an interruption can be brought about by opening a door. If the program sequence is interrupted during the operating mode “Kosher operation” upon filling/heating of the storage tank 25, which may happen for example by opening a door, the conveyor belt automatic dishwasher 1 continues to fill and heat. If the program sequence is interrupted during the operating mode “Kosher operation”, the pumps and the drive mechanism 24 switch off. If the doors on the conveyor belt automatic dishwasher 1 are closed again, the operating mode “Kosher operation” continues exactly from the point at which it was interrupted. In the operating mode “Sabbath operation”, the door switches monitoring opening of the door are non-operational, so that the operating mode “Kosher operation” is not interrupted by opening the door in the operating mode “Sabbath operation”. If the operating mode “Kosher operation” is interrupted by the emergency off switch, the conveyor belt automatic dishwasher 1 is completely switched off. After releasing the emergency off switch, the conveyor belt automatic dishwasher 1 continues exactly from the point at which it was stopped. However, if the conveyor belt automatic dishwasher 1 was situated at washing in the operating mode “Kosher operation”, the program begins again with the step of heating the water before the “Kosher operation”.

A fully terminated operating mode “Kosher operation” must always be interposed between the washing of dishes for milk and washing of dishes for meat. When a rinse process according to the operating mode for meat or milk is started, a light indicating “Kosher operation” goes off on a control panel. The machine control unit always registers the last rinse process carried out, even in the event of a power failure. After carrying out a “Kosher operation”, it is not generally customary to repeat the preceding rinse process. However, if this were to be desirable in exceptional cases, the start button for the corresponding rinse program must be pressed for at least 5 seconds. It must not be possible at any time to switch from the operating mode “Cleaning of dishes for milk products” to the operating mode “Cleaning of dishes for meat/meat products” or vice versa without cleaning the conveyor belt automatic dishwasher 1 by means of the operating mode “Kosher operation”.

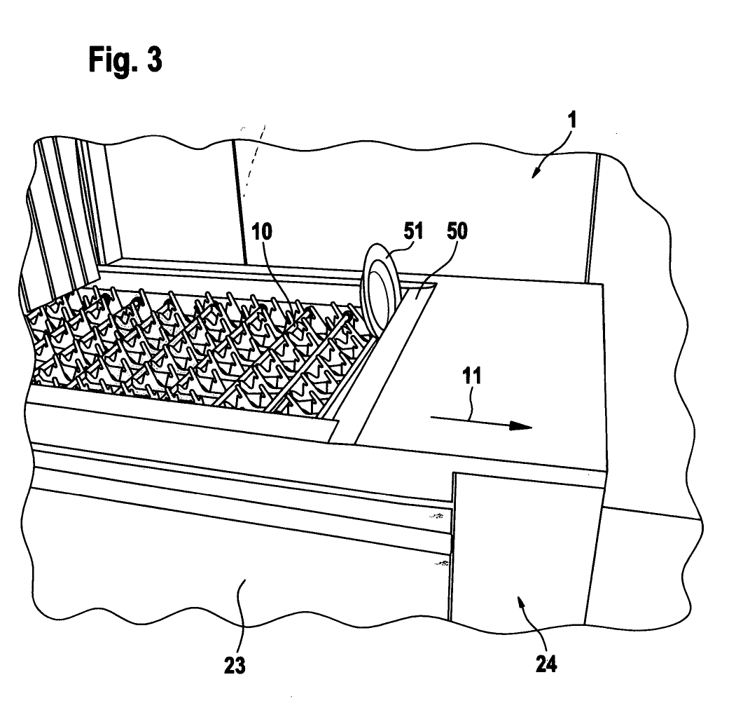

FIG. 3 shows the outlet area of the machine, with a movably arranged limit switch.

The endless conveyor belt 10 made of plastic material reverses in the area of the outlet 23 for the dishes. A dish 51, indicated on the endless conveyor belt 10, has not been removed at the outlet 23 for dishes and, accordingly, strikes against the movably mounted limit switch 50. The latter pivots away and thus triggers a shutdown of the drive mechanism 24 of the endless conveyor belt 10. The direction of advance of the endless conveyor belt 10 is indicated by the arrow 11.

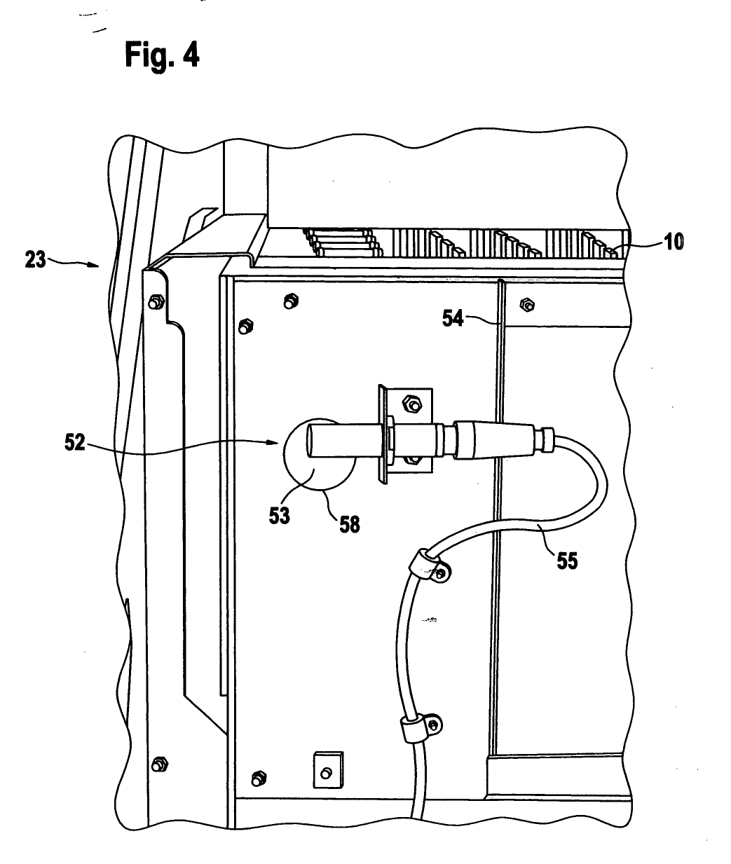

FIG. 4 shows the view of a light barrier arrangement assigned to the movably mounted limit switch. A first light barrier 52 is positioned underneath the outlet 23 for dishes from the conveyor belt automatic dishwasher 1. This light barrier 52 is received on a housing 54. For reasons of clarity, the movably mounted limit switch 50 is not reproduced in FIG. 4. The first light barrier 52, which is secured on the outside of the housing 54, communicates with the machine control unit via a connecting line 55. Formed in the housing 54 of the limit switch arrangement there is a circular opening 58 behind which a movably mounted mirror surface 53 lies. In the non-deflected state of the limit switch, the mirror surface 53 reflects light emanating from the first light barrier 52. The drive mechanism 24 of the endless conveyor belt 10 remains in operation. It is only when a dish 51 not removed from the endless conveyor belt 10 strikes against the limit switch 50 that the mirror surface 53 lying behind the opening 58 pivots away and the reflection of the emitted light beams is interrupted by the first light barrier 52.

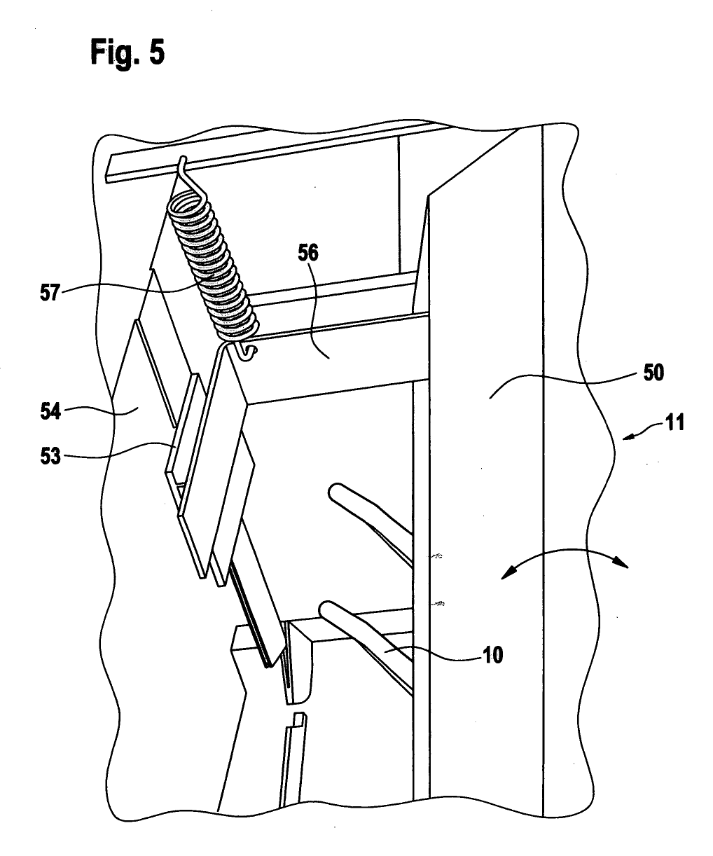

FIG. 5 shows the connection between a mirror surface and the movably mounted limit switch.

In the lower area, the movably mounted limit switch 50, indicated by the double arrow according to FIG. 5, has a bracket 56. The bracket 56 is connected to the machine frame of the conveyor belt automatic dishwasher 1 via a restoring spring 57. The mirror surface 53 is secured on the bracket 56. If the movably mounted limit switch 50 is deflected downward in the direction of the double arrow, for example by a dish 51 striking against it, this results in a pivoting movement of the bracket 56 and, accordingly, a pivoting away of the mirror surface 53 secured on the bracket 56. This mirror surface thus drops from the opening 58 of the housing 54 according to FIG. 4, so that no light is thrown back onto the first light barrier 52.

A switching-off of the drive mechanism 24 of the endless conveyor belt 10 is thus triggered.

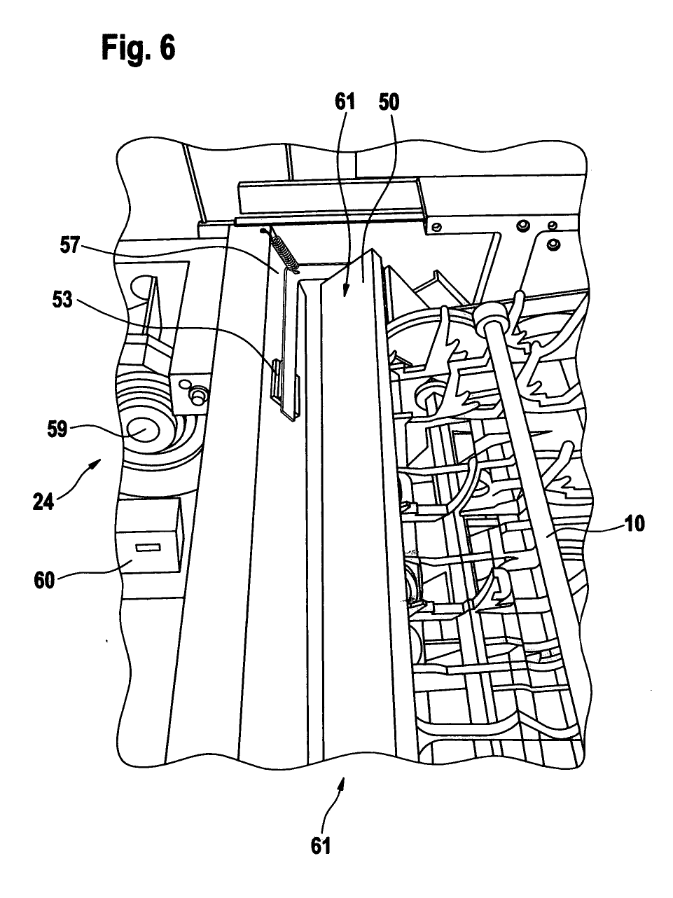

FIG. 6 shows a deflected limit switch. In addition to the function of switching off the drive mechanism 24 of the endless conveyor belt 10, an overload function is also provided on the conveyor belt automatic dishwasher 1 proposed according to the invention. For this purpose, the drive motor 59 is mounted on a tilt bearing 60. The drive motor 59, via a belt or chain drive, moves a guide wheel of the endless conveyor belt 10 in the area of the outlet 23 for dishes from the conveyor belt automatic dishwasher 1. If its forward movement in the direction of advance 11 is impeded by a dish 51 that has not been removed or by an item of cutlery or dish that has been left in the inside of the conveyor belt automatic dishwasher 1, the drive motor 59 is deflected from its normal position on the tilt bearing 60. Because of this, a mirror surface 53 connected to the drive motor 59 moves out from the area of a second light barrier 52 shown in FIG. 1, such that the drive motor 59 can also be switched off in the event of overloading of the endless conveyor belt 10.

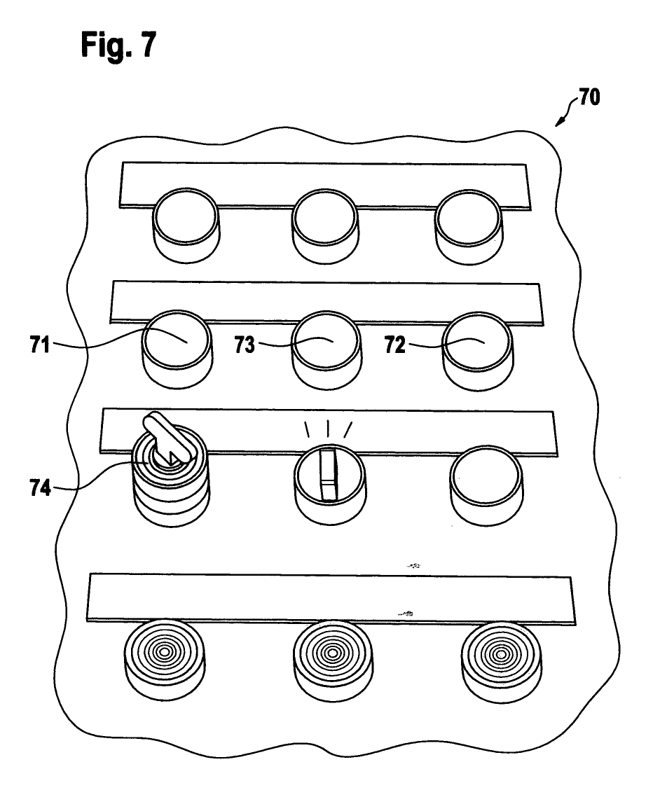

The view according to FIG. 7 shows a control panel of a conveyor belt automatic dishwasher which is able to execute a separate operating mode “Kosher operation” and an operating mode “Sabbath operation”.

The conveyor belt automatic dishwasher 1 shown in FIG. 1 is operated by means of the control panel 70 shown in FIG. 7. The operating mode “Cleaning of dishes for milk products” is switched on via the first switch 71. In this operating mode, the conveyor belt automatic dishwasher 1 is provided with the first curtains 40. After completion of a cleaning program, i.e. a complete passage of the material to be cleaned through the conveyor belt automatic dishwasher 1, it is prohibited to switch directly to the operating mode “Cleaning of dishes for meat/meat products” which can be triggered via a second switch 72. Direct switching from one operating mode to the other operating mode is not possible. This is ensured by the fact that switching from one operating mode to the other, and vice versa, requires the execution of the operating mode “Kosher operation”. To trigger the operating mode “Cleaning of dishes for meat/meat products”, actuation of the third switch 73 for the operating mode “Kosher operation” is imperative. Depending on the preceding operating mode of the conveyor belt automatic dishwasher 1, the first curtains 40 and second curtains 41 suspended therein are first withdrawn and are replaced by the third curtains 42 that are to be used exclusively in the operating mode “Kosher operation”. After use of the third curtains 42 for the operating mode “Kosher operation”, the areas contaminated by spray water in the preceding operating modes of the conveyor belt automatic dishwasher 1 are cleaned by a cleaning fluid which is heated to a temperature of about 90° C. to 95° C., that is to say a temperature which is 5° C. to 10° C. above the maximum temperature occurring in the normal operation of the conveyor belt automatic dishwasher 1. Moreover, in the operating mode “Kosher operation”, the endless conveyor belt 10, consisting of individual plastic components interconnected in an articulated manner, is cleaned by a cleaning system 43 in the form of brushes, so as to be kosher within the meaning of kashrut. Moreover, during the operating mode “Kosher operation”, the inside of the water tank 25 is heated also to a temperature which is above the maximum temperature of the rinse water or fresh water sprayed in the conveyor belt automatic dishwasher 1.

Moreover, the control panel 70 shown in FIG. 7 comprises a fourth switch 74 which can be actuated, for example, by means of a key or such like. Using the fourth switch 74, the conveyor belt automatic dishwasher 1 according to the view in FIGS. 1 and 2 can be converted to an operating mode suited for Jewish holy days, for example the Sabbath. When the conveyor belt automatic dishwasher 1 is switched to this operating mode by actuation of the fourth switch 74, the conveyor belt automatic dishwasher 1 runs substantially automatically, although manual intervention is permitted, and it switches itself off automatically if malfunctions occur. If the conveyor belt automatic dishwasher 1 is operated during the Sabbath, i.e. in the period from Friday to Saturday, it is thus ensured that the conveyor belt automatic dishwasher 1 switches off automatically, in the event of a malfunction of the forward movement of the endless conveyor belt 10, by means of automatic switching-off of the drive mechanism 24, with the result that no damage can occur. Limit switches, with which the forward movement of the endless conveyor belt 10 in the direction of advance 11 is monitored, can be assigned both to the tilt bearing 60 of the drive motor 59 and also to the limit switch 50. The limit switches are preferably configured as first and second light barriers 52. The light barriers 52 emit a light beam onto a mirror surface 53 which is mounted so as to be able to deflect and which is arranged on a bracket 56. If the bracket 56 is deflected because a dish 51 is blocking the forward movement of the endless conveyor belt 10, the mirror 53 reflecting the light beam emitted by the light barrier 52 is deflected from the area of the light barrier 52, such that the receiver part of the light barrier 52 does not sense any reflected beam. By virtue of the absence of the reflected light beam, the drive mechanism 24, 59 of the endless conveyor belt 10 is switched off. After removal of the dish obstructing the forward movement of the endless conveyor belt 10, the deflecting mirror resumes its original position and the conveyor belt automatic dishwasher 1 resumes its operation.

By virtue of the fourth switch 74 for the operating mode “Sabbath operation”, operating mode of the conveyor belt automatic dishwasher, there is no electrical switching function that has to be performed by a person operating the dishwasher. Everything runs automatically. A clock circuit provided in the context of the machine control unit is non-operational; the door switches are also rendered non-operational. In the operating mode “Sabbath operation”, the conveyor belt automatic dishwasher 1 runs at a lower speed. Each operating mode, i.e. the operating mode “Cleaning of dishes for milk products” or “Cleaning of dishes for meat/meat products”, is assigned its own timer. The fourth switch 74 is switched on in good time before the Sabbath. Corresponding first or second curtains 40 or 41 are to be suspended into the conveyor belt automatic dishwasher 1. When the timer assigned to the corresponding operating mode is switched on, the conveyor belt automatic dishwasher starts with the function filling/heating of the storage tank 25 with water. When the desired temperature for rinsing is reached, the respective rinsing procedure begins, until the timer stops the rinsing procedure. The first and second curtains 40, 41 are replaced by the third curtains 42; the operating mode “Kosher operation” is then started via the timer. After completion of the operating mode “Kosher operation”, a new rinsing procedure starts following the adjustments of the timer. To operate the conveyor belt automatic dishwasher 1 in workday mode again, the fourth switch 74 is turned off.

If there is a power failure during the operating mode “Sabbath operation”, or if the main switch is turned to off, then, after voltage is recovered after the power failure, the conveyor belt automatic dishwasher is switched back on via the machine control unit and a normal operating mode “Sabbath operation” is resumed, i.e. the conveyor belt automatic dishwasher 1 starts in the program sequence with filling and heating of the water tanks. If the belt limit switch function is triggered by a dish 51 striking against the limit switch 50, the limit switch 50 is deflected downward and switches off the drive motor 49 of the drive mechanism 40 of the endless conveyor belt 10. The first light barrier 52 is disconnected. Every 15 seconds, the supply voltage of the first light barrier 52 is switched on via a short impulse. If it is found that the limit switch 50 is free again, the forward movement of the endless conveyor belt in the direction of advance 11 begins. If, by contrast, the limit switch 50 is not yet free, the supply voltage is cut out for another 15 seconds.

In the event of an emergency off function occurring, the conveyor belt automatic dishwasher is switched off completely. The emergency off switch is then switched to a voltageless state, and every 60 seconds an impulse of the supply voltage of the emergency off switch is switched on. If this switch is released again, the program begins anew with the step “Start/rinse operation on Sabbath”. If, at the time of the emergency off switch in the operating mode “Sabbath operation”, the “Kosher operation” is activated, the kosher mode runs after disconnection of the emergency off switch.

If, by contrast, the machine program at the time of the emergency off switching is in the wash program in the operating mode “Sabbath operation”, the wash program begins again, after disconnection of the emergency of f switch, with the step “Heating before kosher operation”. If, by contrast, the emergency off switch is not yet released, the supply voltage is cut out for a further 60 seconds.

In the event of detection of an overload function, i.e. caused by obstruction of the forward movement of the endless conveyor belt 10 in the direction of advance 11, the rinse operation is switched off and a belt overload switch is switched to a voltageless state. This is done via the second light barrier 52. Every 30 seconds the supply voltage of the belt overload switch is switched on again by a short impulse. If this switch is disconnected, the rinse operation starts, and if the corresponding belt overload switch is not yet disconnected, the supply voltage is cut out for a further 30 seconds. This cycle can, for example, be executed three times or more. If, after the third time, the belt overload switch is still not free, the cycle is increased to 5 minutes. If this cycle has again been completed three times without success, the conveyor belt automatic dishwasher 1 is switched off completely and can also no longer be started again automatically in the operating mode “Sabbath operation”.

### LIST OF REFERENCE NUMBERS

1 automatic dishwasher with conveyor belt
2 machine inlet
3 preliminary clearing area
4 coarse sieve
5 fine sieve
6 common outflow
7 first rinse zone
8 second rinse zone
9 final rinse zone
10 endless conveyor belt
11 advance direction of material to be cleaned
12 lower spray nozzles
13 upper spray nozzles
14 lower spray nozzles
15 upper spray nozzles
17 heat recovery module
18 cooling register
19 fan
20 drying module
21 dryer
22 drying zone
23 outlet for dishes
24 drive mechanism of endless belt
25 water tank
26 dividing wall
27 trough cover
28 overflows
29 circulating pump
30 filter
31 pump final rinse
32 fresh water final rinse
33 separation
40 first curtain (operating mode Cleaning for milk products)
41 second curtain (operating mode Cleaning for meat products)
42 third curtain (operating mode “Kosher”)
43 cleaning device for endless belt
44 common outflow
45 outflow for preliminary clearing area (separate)
46 second outflow
47 first filling line
48 second filling line
49 valve
50 limit switch
51 dish
52 light barrier
53 mirror surface
54 housing
55 connecting line
56 bracket
57 restoring spring
58 opening
59 drive motor
60 tilt bearing for drive motor
61 deflected position of limit switch 50
70 control panel
71 first switch for operating mode “Milk”
72 second switch for operating mode “Meat”
73 third switch for operating mode “Kosher operation”
74 fourth switch for operating mode “Sabbath operation”

1. A method for operating an automatic dishwasher (1) with an endless conveyor belt (10) which continuously conveys material to be cleaned and which is driven by a drive mechanism (24) controllable from a machine control unit, and the automatic dishwasher (1) can be operated in several operating modes (71, 72, 73, 74), said method comprising the following steps:
a) on switching from a first operating mode (71) “Cleaning of dishes for milk products” to a second operating mode (72) “Cleaning of dishes for meat or meat products” and vice versa, execution of a third operating mode “Kosher operation” (73) is enforced,
b) during the third operating mode (73) “Kosher operation”, the interior of the automatic dishwasher (1) is cleaned with a cleaning fluid whose temperature lies above the rinse water temperature or fresh water temperature occurring in the normal operation of the automatic dishwasher (1),
c) during the third operating mode (73) “Kosher operation”, the endless conveyor belt (10) is cleaned continuously by a cleaning device (43),
d) during the third operating mode (73) “Kosher operation”, the automatic dishwasher (1) is provided with a curtain (43) to be used exclusively in the third operating mode (73) “Kosher operation”, and
e) during a fourth operating mode (74) called “Sabbath operation”, a cut-off function of the drive mechanism (24, 59) of the endless conveyor belt (10) is executed upon overloading and upon interruption via light barriers (52).

2. The method as claimed in claim 1, characterized in that, in the third operating mode (73) “Kosher operation”, the cleaning fluid for cleaning the areas of the automatic dishwasher contaminated in the first operating mode (71) or in the second operating mode (72) has a temperature of between 90° C. and 95° C.

3. The method as claimed in claim 1, characterized in that, during the third operating mode (73) “Kosher operation”, the endless conveyor belt (10) is cleaned continuously on the upper face and lower face by a cleaning system (43).

4. The method as claimed in claim 3, characterized in that, in the third operating mode (73) “Kosher operation”, the cleaning system (43) is provided with a set of cleaning brushes corresponding to the preceding operating mode (71) or (72).

5. The method as claimed in claim 1, characterized in that, in the first operating mode (71) “Cleaning of dishes for milk products”, only the first curtains (40) are suspended in the automatic dishwasher (1).

6. The method as claimed in claim 1, characterized in that, in the second operating mode (72) “Cleaning of dishes for meat products”, only the second curtains (41) are suspended in the automatic dishwasher (1).

7. The method as claimed in claim 1, characterized in that, on switching from the first operating mode (71) “Cleaning of dishes for milk products” to the second operating mode (72) “Cleaning of dishes for meat products” and vice versa, the third operating mode (73) “Kosher operation” is always executed.

8. The method as claimed in claim 1, characterized in that, using a fourth switch (74) provided on the control panel (70), the automatic dishwasher (1) can be converted to an operating mode called “Sabbath operation” in which, if malfunctions occur, the drive mechanism (24, 59) of the endless conveyor belt (10) and of the circulating pumps (29) and of the fresh water supply line is automatically switched off.

9. The method as claimed in claim 8, characterized in that, in the fourth operating mode (74) of the automatic dishwasher (1), a blocking of the advance movement (11) of the endless conveyor belt (10) is detected by a limit switch (50) configured as a light barrier (52).

10. The method as claimed in claim 9, characterized in that the detection of the blocked endless conveyor belt (10) is effected via a light barrier (52) which executes a current interruption function using a mirror which can be deflected via a lever system (56) actuated upon blocking of the advance movement (11) of the endless conveyor belt (10).
